(19) United States
(12) Patent Application Publication
(10) Pub. No.: US 2021/0085127 A1
(43) Pub. Date: Mar. 25, 2021

(54) WOOD PLANK FOR GRILLING

(71) Applicant: Mountain Road Pictures Inc., Ottawa (CA)

(72) Inventor: Tim Alp, Ottawa (CA)

(21) Appl. No.: 17/032,193

(22) Filed: Sep. 25, 2020

Related U.S. Application Data
(60) Provisional application No. 62/905,719, filed on Sep. 25, 2019.

(51) Int. Cl. A47J 37/07; A23B 4/052

(52) U.S. Cl. CPC A47J 37/0786; A23V 2002/00; A23B 4/0523

(57) ABSTRACT

A device for grilling food is disclosed. The device comprises a wood plank having a top surface for receiving the food and a bottom surface for placing on a heat source; and a plurality of through holes defined on the wood plank, each through hole penetrating the top surface and bottom surface. The plurality of through holes enable smoke generated by the heat source or the wood plank to directly smoke a bottom side of the food.

### CROSS-REFERENCE TO RELATED APPLICATIONS

The present application claims priority from U.S. provisional patent application No. 62/905,719, entitled “WOOD PLANK FOR GRILLING”, filed Sep. 25, 2019, which is incorporated herein by reference.

### FIELD

The present invention relates to a cooking device, in particular to a wood plank for grilling food.

### BACKGROUND

Cooking food on hot wood planks is a well-known method of preparing food. For instance plank grilling fish and other foods on cedar or alder wood achieves a tasty result due to the food absorbing the fragrant wood smoke. However, currently available wood planks are not satisfying in smoking the food.

Traditionally the plank must be soaked for an adequate duration of time in water or other liquid, to ensure that the plank does not set on fire when set on a grill, while delivering the optimal amount of smoke.

### SUMMARY

The present invention optimizes the soaking, cooking and smoking process, so that the food being cooked consistently absorbs the optimal amount of smoke.

In an aspect there is provided a device for grilling food, comprising a wood plank having a top surface for receiving the food and a bottom surface for placing on a heat source; and a plurality of through holes defined on the wood plank, each through hole penetrating the top surface and bottom surface, wherein the plurality of through holes enable smoke generated by the heat source or the wood plank to directly smoke a bottom side of the food.

### BRIEF DESCRIPTION OF THE DRAWINGS

Reference will now be made, by way of example, to the accompanying drawings which show example embodiments of the present application, and in which:

FIG. 1 is a top view of an exemplary wood plank, according to an embodiment of the present application;

FIG. 2 is a perspective view of another exemplary wood plank, for grilling food on a barbeque (BBQ) rack;

Similar reference numerals may have been used in different figures to denote similar components.

### DESCRIPTION OF EXAMPLE EMBODIMENTS

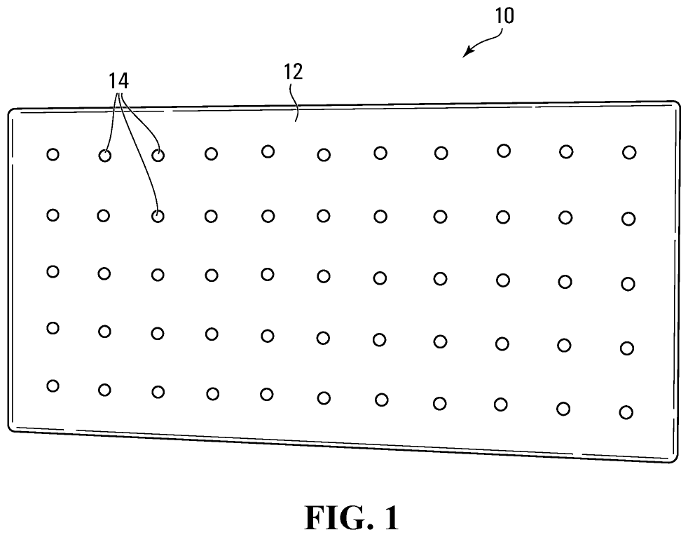

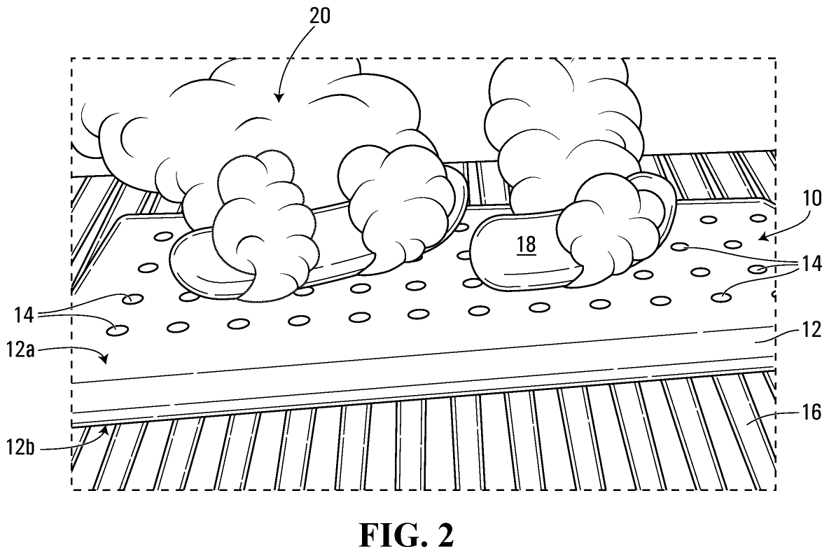

In the examples of FIGS. 1 and 2, a device 10 for grilling food includes a wood plank 12 comprising a plurality of through holes (perforations) 14 on the food plank 12. The wood plank 12 may be used on a BBQ grilling rack 16 for grilling food. The food may be meat, poultry, fish, sausage and vegetables, etc.

The wood plank 12 may be a flat wood board. The wood plank 12 may be made from any type of wood, such as cedar, oak, hickory, maple, alder, apple, cherry, pecan, walnut, birch etc. The wood plank 12 may be a hardwood plank or softwood plank.

The wood plank 12 may have various shapes and dimensions and any size appropriate for grilling can be used in conjunction with the present invention. In some examples, the wood plank 12 may be substantially rectangular. For example, the wood plank 12 may have a dimension of approximately 12 to 17 inches in length, 6 to 8 inches wide and 0.5 to 2 inches in height. The wood plank 12 may also have other shapes such as squares, circles or ovals.

The thickness or height of the wood plank 12 may be varied. If the wood plank 12 is thicker, the durability of the wood plank 12 in permitted repeated uses will be improved, and more foods can be grilled on the wood plank 12 during the lifetime of the wood plank 12.

For example, if the thickness of the wood plank 12 is 0.5 inches, the wood plank 12 may be burned out after the wood plank has been used to grill food once and its reuse is not recommended. However, if the thickness of the wood plank 12 is approximately ¾ inches and/or 1 inch, the wood plank 12 may still be reused for 1, 2 or more times.

The wood plank 12 has a top surface 12a and a bottom surface 12b. The top surface 12a may receive the food and the bottom surface 12b may be directly placed on the BBQ rack 16. The heat source, such as fire flame generated by wood, hot charcoal, propane or natural gas, may directly heat the bottom surface 12b of the wood plank 12. Each through hole 14 penetrates through the top surface 12a and bottom surface 12b of the wood plank 12. The through holes 14 may be drilled, for example by a drill, through both the top surface 12a and the bottom surface 12b of the plank 12.

The through holes 14 may have different dimensions or diameters. In some examples, each through hole 14 is substantially circular, and may have a diameter of 0.1-0.6 inches. For example, the through hole 14 has a diameter of 17/64 inches. The through holes 14 may have different shapes, for example polygonal and oval, as long as the smoke generated by the heat source or by the wood plank 12 can rise from the bottom surface 12b, via the through holes 14, to smoke the food placed on the top surface 12a.

All the through holes 14 may have the same size or different sizes. In the example of FIG. 1, the wood plank 12 has 5 columns and 11 rows of through holes 14, for a total of 55 through holes 14. In the example of FIG. 2, the wood plank 12 has 4 columns and 13 rows of through holes 14, for a total of 52 through holes 14. The number of the through holes 14 in the wood plank 12 may be varied, based on the size of the planks 12, the size of the through holes 14, and the density of the through holes 14 on the planks 12.

In some examples, the through holes 14 may be evenly distributed on the wood plank 12, or the through holes 14 have higher density in some areas of the wood plank 12 while other areas of the plank 12 have a lower density.

Prior to grilling, the wood plank 12 may be soaked in a liquid for a desired period, such as 1 to 8 hours or longer. The liquid may be water, wine, beer, juice or any other flavoured consumable liquids. The plurality of through holes 14 increase the exposure of the portion of the wood plank 12 between the top surface 12a and the bottom surface 12b to the liquid. The increased exposure may accelerate the soaking process of the wood plank 12. Therefore, the plurality of through holes 14 may reduce the time for soaking the wood plank 12 than wood planks without through holes. Soaking the plank 12 prolongs the use of the plank 12 by delaying the burning of the plank, and imparts moisture and flavor of the liquid and/or the wood to the food cooked on the top surface 12a of the wood plank 12.

As illustrated in the example of FIG. 2, in use, the wood plank 12 may be placed on the grill. The bottom surface 12b may be directly or indirectly placed on the grilling rack 16. The food 18 may be placed on the top surface 12a of the plank 12. A heat source such as hot charcoal or fire/flames generated from gas or wood, may be used to heat the wood plank 12. The smoke 20 may be generated by the heat source and/or by the wood plank 12 when the bottom surface 12b of the wood plank 12 is burned. The smoke 20 may be used to smoke, through the plurality through holes 14, the food placed on the top surface 12a of the wood plank 12. Therefore, the plurality of through holes 14 allow the heat and smoke generated by the heat source and/or the bottom surface 12b to directly heat or smoke the food 18 placed on the top surface 12a. Food grilling on a wood plank without through holes is generally indirectly smoked from the top and surrounding sides of the foods, but not from the bottom side of the food. The through holes 14 thus allow the food 18 to be more evenly smoked and grilled from the bottom side, the top side and the surrounding sides, and improve the smoking effect of the food. Therefore, the food 18 smoked by the device 10 may have a stronger smoky flavor and the food can be grilled faster than the food smoked by the wood plank without through holes.

In some examples, in addition to smoke flavour, the wood plank 12 may also add to the food 18 a wood flavour generated from the wood plank 12.

The wood plank 12 may be hardwood or softwood. Hardwood endures heat longer and thus adds more flavor to the food through the smoke that is produced as the wood plank 12 is burned. Softwoods deteriorate by burning more quickly than hardwood and therefore may add less flavor to the grilled foods than the hardwood.

Certain adaptations and modifications of the described embodiments can be made. Therefore, the above discussed embodiments are considered to be illustrative and not restrictive.

1. A device for grilling food, comprising:
a wood plank having a top surface for receiving the food and a bottom surface for placing on a heat source; and
a plurality of through holes defined on the wood plank, each through hole penetrating the top surface and bottom surface,
wherein the plurality of through holes enable smoke generated by the heat source or the wood plank to directly smoke a bottom side of the food.

2. The device of claim 1, wherein the wood plank is made from cedar, oak, hickory, maple, alder, apple, cherry, pecan, walnut, or birch.

3. The device of claim 1, wherein the wood plank has a dimension of approximately 12 to 17 inches in length, 6 to 8 inches in width and 0.25 to 1.25 inches in thickness.

4. The device of claim 1, wherein each through hole is substantially circular, and has a diameter of 0.1-0.6 inches.

5. The device of claim 1, wherein the wood plank has 5 columns and 11 rows of through holes for a total of 55 through holes.

6. The device of claim 1, wherein the wood plank has 4 columns and 13 rows of through holes, for a total of 52 through holes.

7. The device of claim 1, wherein the through holes are substantially evenly distributed on the wood plank.

8. The device of claim 1, wherein the wood plank is soaked in a liquid for 1 to 8 hours or longer prior to grilling the food.

9. The device of claim 8, wherein the liquid is water, wine, juice, beer, or flavoured consumable liquids.

10. The device of claim 1, wherein the wood plank is a hardwood plank.

11. The device of claim 1, wherein the wood plank is a softwood plank.
